(19) United States
(12) Patent Application Publication
(10) Pub. No.: US 2021/0374869 A1
(43) Pub. Date: Dec. 2, 2021

(54) METHOD AND APPARATUS FOR INSURANCE AND CALCULATION OF PREMIUMS FOR FIREARMS AND RELATED EQUIPMENT

(71) Applicant: Wendell D. Brown, Henderson, NV (US)

(72) Inventor: Wendell D. Brown, Henderson, NV (US)

(21) Appl. No.: 17/121,539

(22) Filed: Dec. 14, 2020

Related U.S. Application Data
(63) Continuation of application No. 15/864,966, filed on Jan. 8, 2018, now abandoned.
Application No. 15/864,966 is a continuation of application No. 14/214,198, filed on Mar. 14, 2014, now abandoned.
(60) Provisional application No. 61/781,910, filed on Mar. 14, 2013.

(51) Int. Cl. G06Q 40/08

(52) U.S. Cl. CPC G06Q 40/08

(57) ABSTRACT

A method of calculating an insurance premium for a firearm and related equipment purchased by a buyer includes receiving information of the buyer by a computer, and collecting data from one or more databases about the buyer by the computer in response to the received information. The method calculates the insurance premium based on a type of the firearm purchased and related equipment and the collected data.

### CROSS-REFERENCES TO RELATED APPLICATIONS

This is a Continuation Application of U.S. Patent Application No. 15/864,966, filed Jan. 8, 2018, which is a Contivation Application of U.S. patent application Ser. No. 14/214,198, filed Mar. 14, 2014, which claims the benefit of U.S. Provisional Patent Application No. 61/781,910, filed Mar. 14, 2013, the contents of which are incorporated herein by reference in their entirety.

### BACKGROUND OF THE INVENTION

The present disclosure relates to a method and system for calculating insurance premiums, and more particularly to a method and system of “real-time” calculation of insurance premiums for firearms and related equipment.

Gun ownership, even in the responsible people, has the risk of causing serious injury to others. Gun owners may want to know the cost of liability insurance when buying or owning a firearm and/or related products.

Common types of insurance are house insurances and vehicle insurances. Systems for determining insurance premiums for a house and/or for a vehicle are known. For example, house insurance premiums may be easily calculated based on the replacement value of the house and its location, e.g., whether the house is located in a flood or hurricane zone, and the premiums can be determined and stored in a database. If a buyer of a property located in a certain area wanted to know the premium rate, the buyer would have to contact an insurance agent who then accesses the database to look for a rate and communicates the rate to the buyer. Insurance premiums for a vehicle may be determined based on the vehicle model, its current value, and the driving record, age, gender, profession, place of residence, and traffic records of the insurer. Unlike the property and vehicle insurance premiums, the process of calculating insurance premiums for a firearm can be complex and inefficient because it may depend on many factors including behavioral risks of a customer that are not readily available to an insurance company.

Thus, there is a need for a method and system of real-time calculation of premiums for firearms and related equipment so that the buyer of a firearm knows about the costs of the insurance prior to completing the transaction.

### BRIEF SUMMARY OF THE INVENTION

Embodiments of the present invention relate to an automated method and system of calculating an insurance premium for firearm and related equipment and outputting the calculated premiums to a buyer seeking insurance coverage without intervention of an insurance agent. In some embodiments, a method includes obtaining information of the buyer using a computer by a seller (e.g., at a point-of-sale) and collecting data online using one or more searching engines about the buyer in response to the obtained information. The inputted information by the buyer may include age, gender, education, level of firearm training (familiarity of the firearm type from the buyer), marital status, occupation, location of residence, employment history, and the like. The computer then calculates the insurance premium based on the to be purchased firearm type and related equipment and the online collected data. The collected data may include police reports pertinent to the buyer, his online social profile, traffic violations, and the like. In an embodiment, the computer may obtain the buyer's agreement prior to collecting buyer's data using any search engines.

In another embodiment, a non-transitory computer-readable medium containing a number of program codes is provided to a computer located at a point of sales. The program codes are executable by the computer and configured to provide an insurance premium in real-time to a buyer of a firearm and related equipment. The program codes may include a first program code configured to obtain information of the buyer, a second program code configured to collect data online pertinent to the buyer based on the information, and a third program code to calculate the insurance premium based on the type of firearm and related equipment that the buyer wants to purchase and the collected data. The program codes may also include codes to adjust the calculated insurance premium by correlating additional purchases related to the firearm and based on a risk assessment compiled from data obtained online.

In yet another embodiment, a system for automatically calculating an insurance premium for a firearm purchased by a buyer from a seller includes a computer, and an input device coupled to the computer and configured to receive information inputted by the buyer. The system also includes a communication interface device configured to access one or more databases and to collect data pertinent to the buyer based on the inputted information. The computer calculates an insurance premium based on the purchased firearm type and related equipment. The system further includes an output device to output in real-time the calculated insurance premium to the buyer and alert the buyer of any rate changes. The system may adjust the insurance premium in real-time with additional equipment acquired together with the firearm.

The following description, together with the accompanying drawings, will provide a better understanding of the nature and advantages of the claimed invention.

### BRIEF DESCRIPTION OF THE DRAWINGS

FIG. 1 is a simplified block diagram of a system for calculating an insurance premium for a firearm purchased by a buyer according to an embodiment of the present invention.

FIG. 2 is a simplified block diagram of a networked system for calculating an insurance premium for a firearm purchased by a buyer according to an embodiment of the present invention.

FIG. 3 is a flow chart illustrating an embodiment of a method for calculating an insurance premium for a firearm purchased by a buyer according to an embodiment of the present invention.

### DETAILED DESCRIPTION OF THE INVENTION

Embodiments of the present invention provide an automated method and system of real-time calculation of insurance premiums of firearms and related equipment for a buyer at a point of sales without intervention of an insurance agent or a store personal. As used herein, the term “buyer” may refer to a potential customer, an individual, an insurance policy holder that seeks to query the insurance premium (price, cost) to obtain an insurance policy. The buyer may have a business relationship with the seller or the insurance company, or the buyer may not yet have a business relation with the seller. The term “computer-readable medium” refers to any medium that participates in providing software (sets of instruction, data structures, program codes), which may be read and executed by a computer.

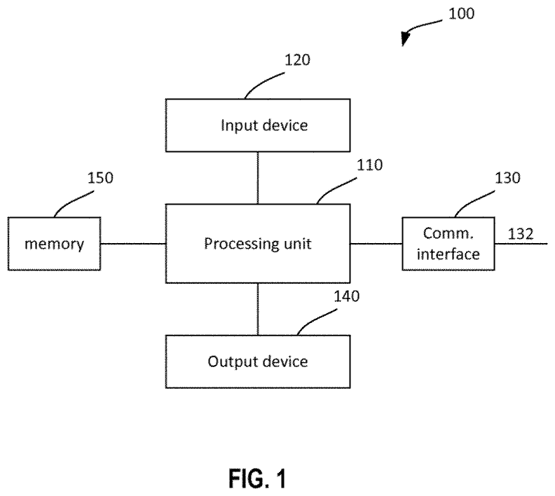

FIG. 1 is a simplified block diagram of a system 100 for calculating an insurance premium for a firearm purchased by a buyer according to an embodiment of the present invention. System 100, which is a computer, may include a processing unit 110, an input device 120, a communication interface device 130, and an output device 140. Processing unit 110 may be a general-purpose personal computer or a hardware device (a tablet PC, a PDA) configured to execute program codes stored in a memory device 150. Processing unit 110 may include one or more microprocessors or central processing units (CPU). Memory device 150 can include non-volatile memory devices (e.g., ROM, CD-ROM, Flash memory devices, optical storage devices, magnetic storage devices, and the like) and/or random access memory devices (DRAM, SRAM, and the like). Input device 120 can include a keyboard or a touch display panel configured to interface with a user. Communication interface device 130 can have an interface unit 132 configured to connect system 100 to a network (e.g., the Internet) and to communicate with one or more remote database storages (servers). Output device 140 can be a printer or a part of the touch display panel to present output data to a user. In an embodiment, system 100 may be an information kiosk or a server located in a store selling firearms and related equipment.

In an embodiment, a buyer wants to know the cost (rate) of an insurance premium of a firearm the buyer intends to purchase. The buyer may input information by filling out an application form displayed by system 100 on input device 120. The application form may include fields for personal information that must be completed, such as the buyer's age, gender, marital status, experiences with the firearm in transaction or any other firearms, the number of firearms already in possession, the usage frequency, training courses attended and passed, certifications, education, occupation, location of residence, employer, employment status, employment history, income, etc. The fields may also include the type of firearm (e.g., the gun model) the buy intends to purchase. Other information may also include buyer's social networking website activities (e.g., twitter tweets, Facebook postings, LinkedIn, and the like). All inputted information is then stored in memory unit 150.

In an embodiment, input device 120 may include a QR code scanner or a magnetic-stripe reader configured to read information stored in the buyer's credit card or identification card. In an embodiment, input device 120 may include a digital camera configured to take a picture of the buyer. System 100 may include a facial recognition program configure to compare the picture with a facial image stored in the buyer's credit card or identification card for identity verification. In another embodiment, a store personal may verify the buyer identity visually and enter the buyer's information through input device 120.

Based on the inputted information, computer 110 may cause communication interface device 130 to go online through a communication link 132 to search additional data pertinent to the buyer. Communication link 132 can be a wired medium, an optical medium, or a wireless medium. In an exemplary embodiment, communication interface device 130 may access remote databases using an internet Transfer Protocol (TCP/IP) or other communication protocols to retrieve additional information data pertinent to the buyer. Examples of publicly available databases can include federal, state, regional, local databases such as police reports. Other information sources can be Facebook, Twitter, YouTube, LinkedIn, or online people search engines.

Memory unit 150 may contain a number of program codes that are executable by computer 110. For example, the program codes may include a first program code causing input device 120 to display input fields to be filled by the buyer, a second program code causing communication interface 130 to access the network to collect data pertinent to the buyer in response to the filled fields, and a third program code causing the computer to calculate an insurance premium based on the filled fields and collected data.

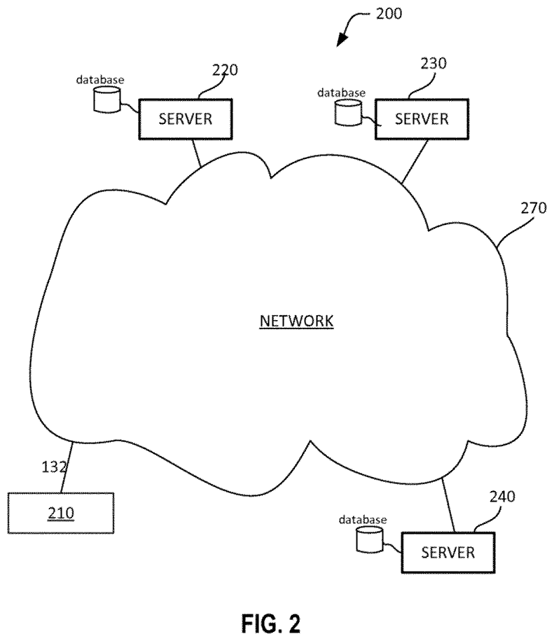

FIG. 2 is a simplified block diagram of a networked system 200 for calculating an insurance premium for a firearm purchased by a buyer according to an embodiment of the present invention. Networked system 200 includes a computer system 210 and a number of remote servers 220, 230, and 240. Computer system 210 can be a self-service kiosk or a system such as system 100 described above with reference to FIG. 1. Servers 220, 230, 240 can include databases of federal, state, regional or local databases that may contain the buyer's legal activity or status (convictions, warrants, education background, etc.). Computer system 210 is communicatively connected to servers 220, 230, 240 through a network 270, which can be a wireless network, a wide area network, and/or a global network (e.g., the Internet). Network 270 includes not only physical networks, but also content networks residing across the physical networks. In the example shown in FIG. 2, one computer system 210 and three servers are used. But it is understood that the number is arbitrary chosen for describing the example embodiment and should not be limiting. For example, computer system 210 may be an automated quote system at a point-of-sales in a firearm store. Servers 220, 230, and 240 can be physically dispersed in different states and may contain databases of federal/FBI arrest records. Servers 220, 230, and 240 may contain databases of local criminal records including robbery records, domestic violence records, and the like.

Servers 220, 230, and 240 may also be associated with insurance providers and contain databases that maintain names and records of policy holders in other types of insurances (e.g., house, car, health). Records may include behaviors of policy holders, such as hobbies, character-based traits obtained from social networking websites, psychological attraction/attention to specific people, health history (depression, alcohol abuse), etc.

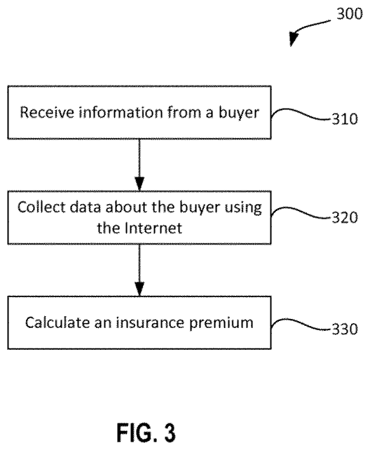

FIG. 3 is a flow chart illustrating an embodiment of a computer-implemented method 300 for real-time calculating an insurance premium for a firearm purchased by a buyer according to an embodiment of the present invention. At block 310, a buyer wanting to get an insurance quote may input his/her information into a computer system such as computer system 100 using an input device such as input device 120 described above. The inputted information may include the buyer's age, race, gender, location of residence, social security number, marital status, number and age of children, if any, education, military services, membership and frequency of gun trainings at local shooting ranges, etc. Upon obtaining the information provided by the buyer, the computer system may collect additional data pertinent to the buyer by searching the Internet through a communication interface device such as communication interface device 130. The additional data collected by the computer system may be retrieved using various processes such as accessing federal, state, regional, and local servers, and various social networking websites. The additional data can include but not limited to conviction records, restraining orders, divorce settlements, separation agreements, social activities. Method 300 can further obtain “soft data” of the buyer by comparing the buyer's provided information with the collected additional data from online searches. For example, if there are discrepancies between buyer's inputted information and the online collected information, the buyer may be sloppy or careless, or the incorrect information may be intentionally provided for purposes of deception.

Method 300 may use a point-based process to assign risk scores corresponding to the assessed risk level of the buyer based on the provided information and the collected data. Analysis of buyer's risk level may be based on various inputs such as the discrepancies between buyer's provided information and the online collected data. The assigned risk scores may be associated with the type of the firearm (gun model) and/or the accessories, the location of the residence, social behaviors of the buyer obtained by compiling the buyer's provided information and data collected online via various public and private websites. For example, if the buyer's residence is in an urban area, the assigned point may be higher than if the buyer's residence is in a rural area. The assigned scores may also depend on where and how the buyer will store the purchased firearm. If the firearm is stored in a local shooting range, then the computer system can adjust the risk scores accordingly.

In an embodiment, the risk score may be determined depending not only on the firearm itself, but also on the firearm related items, such as ammunitions, other accessories (safety locks, gun-mounts), and the associated amounts. If the buyer also acquires a large amount of ammunitions, e.g., an amount exceeding an average by many times, the transaction may affect the risk score. In an embodiment, the computer calculates the risk score by taken into consideration the number of each transaction (e.g., the number of firearms, the amount of ammunitions purchased). Each item may be assigned a numerical value. The computer may calculates the risk score by summing up the numeric value of each purchased items and adjusts the sum by a coefficient (risk factor) dependent on the purchased amount. The computer may also calculate the risk score using any arithmetic operations.

In an embodiment, method 300 may predict risk behaviors of the buyer using a correlation between data obtained from social media systems (e.g., Facebook, Twitter) with data obtained from federal (e.g. FBI), state, regional, local databases. In an embodiment, the buyer's risk analysis can be performed based on the buyer's social graph (a graph showing the buyer's relations with other Internet users). For example, the risk score will be adjusted if the buyer is also buying or selling ammunitions online. In another embodiment, the computer may update the score based on events or transaction between the buyer and seller. For example, if the buyer also purchases a large number of ammunitions with the firearm, or if the buyer also purchases a safety lock for the firearm, then the computer system may adjust the score accordingly. At block 330, the computer system may calculate an insurance premium based on a type of firearm (e.g., gun model) and the collected data. In an embodiment, the computer system may update the insurance premium in real-time based on events and/or transactions between the buyer and seller. For example, if the buyer purchases multiple firearms and a large number of ammunitions associated with the multiple firearms, then the computer system may adjust the premium accordingly and issues a quote in real-time through an output device.

In some embodiments, the invention can be partially or wholly implemented with a non-transitory computer-readable medium containing a number of program codes or hardware modules. The invention may calculate behavioral risks of the buyer by correlating data collected online and the number of accessories in transaction. Collected data may include the number of traffic violations, ownership violations of firearm and related equipment, miscellaneous major and minor offenses, claimed losses of properties, mental health history, hunting licenses, ownership of life insurances, credit scores, reckless driving violations, citations of driving under the influence (DUI), etc.

The quote may include an option for the buyer either to accept or decline. In the event that the buyer accepts the insurance quote, the method will include a process to receive a purchase agreement from the buyer and a process to obtain payment directly from the buyer. In an embodiment, the purchase agreement is signed by the buyer to authorize the seller to make the charge to the buyer's credit card. The purchase agreement, information provided by the buyer, data collected online, the assessed risk score, the firearm and related equipment transaction are stored in a local server or in a third-party remote server.

In some embodiment, method 300 may alert the buyer's insurance provider about the behavioral change of the buyer so that the insurance provider may intervene while the buyer is making a firearm purchase. For example, the buyer may be notified (and would need to agree at that time) that the buyer's insurance rates will increase. If the buyer does not approve the increase, then the purchase process may be terminated because the buyer would not then have the necessary ongoing insurance. Embodiments of the present invention thus provide a real-time computation of required additional insurance, which is presented at the time of purchase and must be agreed to. For example, the computer may display the message “By completing this purchase, and to allow this purchase now, you agree that your annual firearm insurance policy premiums will increase from $295 to $3,445 annually. Sign below to authorize and to make an immediate payment now for your increased insurance premium rate. Or hit cancel if you do not agree.”

In an embodiment, method 300 may also include a process of obtaining an agreement from the buyer whether the collected data can be shared with other computers located in other locations. If the buyer agrees that the provided information and collected data can be shared, the method will move the information and data to a storage (or server) that is accessible by other computers (or servers).

In some embodiments, the buyer may be required to enter a password on a mobile device registered to the buyer. This mobile device, in addition to accepting verification (i.e., enter a password or a PIN) that the buyer knows, verifies that the buyer is buying the items (ammunition, gun, and the like). In an embodiment, the mobile device can be a mobile phone having a built-in GPS device to provide the location and time of the purchase transaction. The GPS information may be used as an input into a risk analysis in an embodiment.

In some embodiments, the above described processes may be implemented in program codes stored in a non-transitory computer-readable medium and executed by a processor. The program codes may perform a part or all of the processes described in blocks 310 through 330.

In another embodiment, the above described processes may be implemented in hardware modules. For example, the computer system may be disposed at a local firearm retail shop and communicatively connected to a number of local or remote servers through a local area network, a metropolitan area network, a wide area network, or a global network such as the Internet. The computer system may be system 100 shown in FIG. 1, which includes processing unit 110 coupled to memory device 150, input device 120, communication interface device 130, and output device 140.

The above description is intended to be illustrative, and not restrictive. While the invention has been described in terms of a method and system for calculation insurance premiums for firearms and related equipment, those skilled in the art will recognize that the invention can be practiced with modifications within the scope of the claims. For example, the above-described embodiments can be used for calculation of premiums for other items such as alcohol, liquor, tobacco, chemicals transactions or other transactions.

While the intention has been described with respect embodiments, one skilled in the art will recognize that numerous modifications are possible. Thus, it will be appreciated that the invention is intended to cover all modifications and equivalents within the scope of the following claims.

What is claimed is:

1. A method of calculating an insurance premium for a firearm and related equipment purchased by a buyer, the method comprising:
receiving information of the buyer by a computer;
collecting data from one or more databases about the buyer by the computer in response to the received information; and
calculating the insurance premium based on a type of the firearm and the collected data.

2. The method of claim 1, wherein receiving the information of the buyer comprises:
displaying on a display device a form by the computer; and
filling the form by the buyer.

3. The method of claim 1, wherein receiving the information of the buyer comprises:
reading a QR code disposed on a credit card or identification card of the buyer.

4. The method of claim 1, wherein collecting data comprises:
querying information data related to the buyer by the computer using one or more search engines; and
verifying at least a portion of the obtained information of the buyer with the queried information data.

5. The method of claim 4, wherein the queried information data is obtained by accessing one or more servers disposed in a private website or a public website.

6. The method of claim 5, further comprising:
assessing a risk score by correlating at least a portion of the queried information data and a number of accessories associated with the firearm.

7. The method of claim 6, wherein the at least a portion of the queried information data comprises a social profile and a police record of the buyer.

8. The method of claim 6, further comprising:
alerting the buyer of a change of the insurance premium based on the assessed risk score.

9. The method of claim 1, further comprising:
displaying the insurance premium to the buyer; and
receiving an agreement from the buyer.

10. A non-transitory computer readable medium having a plurality of program codes executable by a computer for calculating an insurance premium for a firearm and related equipment purchased by a buyer, the non-transitory computer readable medium comprising:
a first program code configured to receive information of the buyer by a computer;
a second program code configured to collect data from one or more databases about the buyer based on the obtained information; and
a third program code configured to calculate the insurance premium based on a type of the firearm and related equipment and the collected data.

11. The non-transitory computer readable medium of claim 10, further comprising;
a fourth program code configured to query information data related to the buyer using one or more online search engines to access one or more databases stored in a private website or a public website; and
a fifth program code configured to verify at least a portion of the obtained information of the buyer with the queried information data.

12. The non-transitory computer readable medium of claim 11, further comprising:
a sixth program code configured to correlate at least a portion of the queried information data and a number of accessories associated with the firearm to obtain a risk assessment.

13. The non-transitory computer readable medium of claim 10, further comprising:
a seventh program code configured to receive a purchase agreement from the buyer; and
an eighth program code configured to obtain payment directly from the buyer.

14. The non-transitory computer readable medium of claim 10, further comprising:
a ninth program code configured to assess a risk score by correlating at least a portion of the obtained data; and
a tenth program code configured to generate an alert to the buyer in response to the assessed risk score.

15. The non-transitory computer readable medium of claim 10, wherein the one or more databases are disposed in a private website or a public website.

16. A system for calculating an insurance premium for a firearm and related equipment purchased by a buyer, the system comprising:
a computer disposed;
an input device including a display screen coupled to the computer and configured to receive information entered by the buyer; and
a communication interface device coupled to the computer and configured to access one or more databases and to collect information data pertinent to the buyer;
wherein the computer calculates the insurance premium based on a type of the firearm and the collected information data.

17. The system of claim 16, wherein the computer comprises a memory device configured to store the entered information, the memory device comprising a plurality of program codes being executable by the computer to:
prompt the buyer to enter the into a form displayed on the display screen; and
cause the communication interface device to establish a connection to a private website or a public website.

18. The system of claim 17, wherein the connection comprises a wired medium, an optical medium, a wireless medium, or a combination thereof.

19. The system of claim 16, wherein the input device comprises a reader configured to scan a QR code disposed in an identification card or a credit card of the buyer.

20. The system of claim 16, wherein the computer assesses a risk score of the buyer by correlating at least a portion of the collected information data and issues an alert to the buyer in response to the assessed risk level.

21. A system for calculating an insurance premium for a purchase by a buyer, the system comprising:
a computer;
an input device including a display screen coupled to the computer and configured to receive information entered by the buyer; and
a communication interface device coupled to the computer and configured to access one or more databases and to collect data pertinent to the buyer, wherein the computer assesses a risk score based on at least a portion of the collected data and a purchased item and calculates the insurance premium based on the purchased item and a number of accessories associated with the purchased item and the assessed risk score.
